(19) United States
(12) Patent Application Publication
(10) Pub. No.: US 2008/0054542 A1
(43) Pub. Date: Mar. 6, 2008

(54) Machine vice with retractable parallels

(76) Inventor: Daniel Gelbart, Vancouver (CA)

Correspondence Address: DAN GELBART, 4706 DRUMMOND DR., VANCOUVER, BC, V6T-1B4, US

(21) Appl. No.: 11/514,860

(22) Filed: Sep. 5, 2006

(51) Int. Cl. B25B 5/16

(52) U.S. Cl. 269/277

(57) ABSTRACT

Retractable parallels are mounted in slots cut into the jaws of a machine vice. When parallels are retracted the vice is similar to a regular vice. When parallels are in the extended position, they are used to support the workpiece is a similar manner to traditional parallels. Multiple sets of retractable parallels can be used at different elevations. Parallels extend automatically by spring pressure and retract by pressure from workpiece or other objects

### FIELD OF INVENTION

The present invention is in the field of workholding devices for machine tools

### BACKGROUND OF THE INVENTION

When a workpiece is clamped in a machine tool vice, it is normally supported by a pair of parallels, a shown in FIG. 1, where removable parallels 3 support workpiece 1. Prior art methods attempted to replace the parallels by insertable pins, as shown in U.S. Pat. Nos. 5,419,540 and 3,463,479. Pins can not only replace simple parallels but also angled parallels, however a selection of pins has to be maintained, offering little savings over maintaining a selection of parallels near the vice.

It is the object of this invention to make the parallels an integral part of the vice and eliminate the need to maintain separate parallels. The parallels are retractable, so they do not interfere with operations or areas not requiring parallels. The retractable parallel have a continuous support surface similar to traditional parallels. This is important in order to spread the vertical load during set up and machining. Prior art round pins make only a line contact with workpiece, therefore vertical position is not accurate as workpiece can easily be dented by the line contact. The retractable parallels make a full area contact.

### SUMMARY OF THE INVENTION

Retractable parallels are mounted in slots cut into the jaws of a machine vice. When parallels are retracted the vice is similar to a regular vice. When parallels are in the extended position, they are used to support the workpiece is a similar manner to traditional parallels. Multiple sets of retractable parallels can be used at different elevations. Parallels extend automatically by spring pressure and retract by pressure from workpiece or other objects.

### BRIEF DESCRIPTION OF THE DRAWINGS

FIG. 1 is an isometric view of prior art vice using separate parallels.

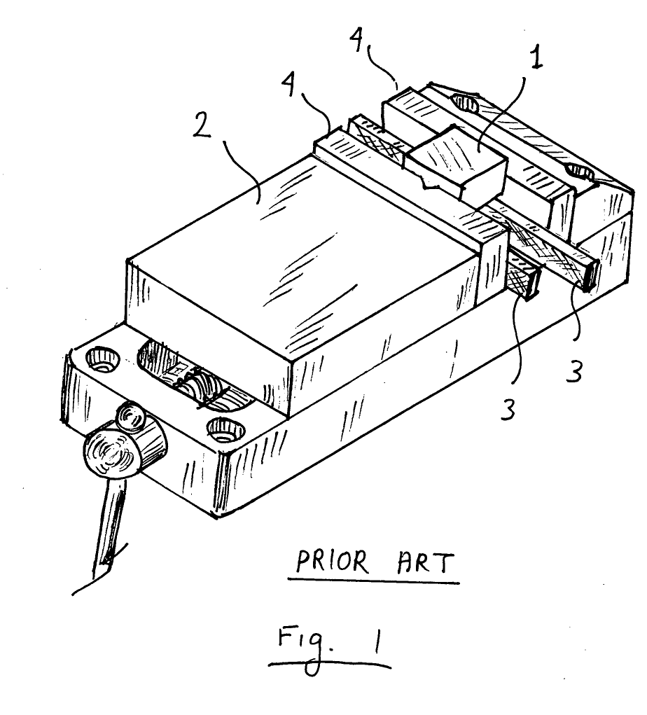

FIG. 2 is an isometric view of a vice according to the invention.

FIG. 3 is an exploded view of the invention.

FIG. 4 is a cross-section view of the invention.

### DESCRIPTION OF PREFERRED EMBODIMENT

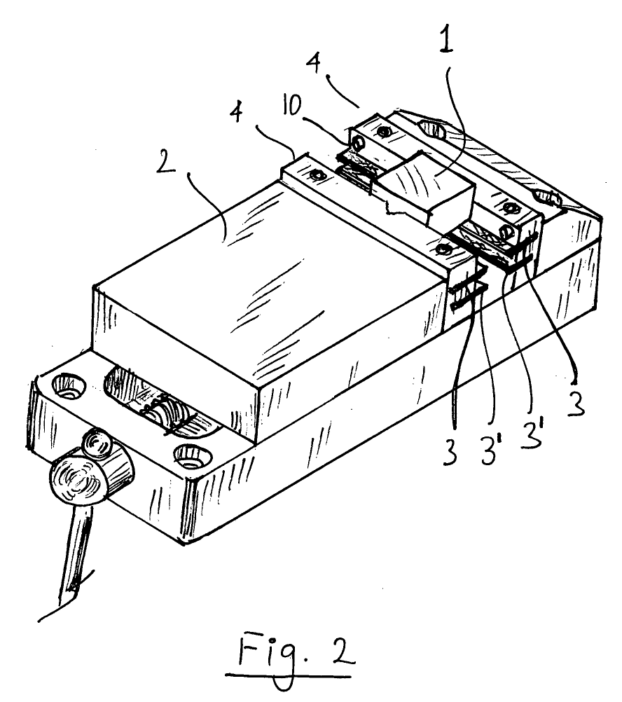

Referring now to FIG. 2, a workpiece 1 is held by jaws 4 of machine vice 2. Retractable parallels 3 are spring loaded and extend from jaws 4 to support workpiece 1. Multiple sets of parallels 3 can be built into a single set of jaws 4, as shown by second set of retractable parallels 3′. Optional retractable pins 10 are used as horizontal stops.

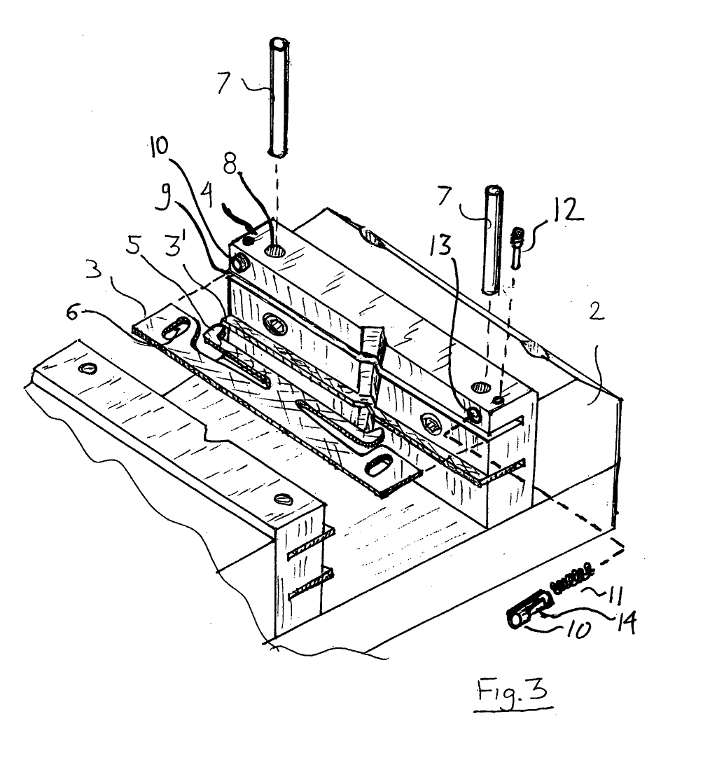

FIG. 3 shows an exploded view of the invention. Retractable parallel 3 fits accurately into a slot 9 cut into jaw 4. In the preferred embodiment both parallel 3 and jaw 4 are made of hardened and tempered tool steel. Parallel 3 is ground on both sides after hardening and slot 9 is finished by grinding after hardening of jaw 4. It is important to maintain a very good fit between slot 9 and parallel 3. Thickness of parallel 3 is about 2 mm for small and medium size vices and about 3 mm for large vices. When extended, it typically protrudes a 2-5 mm. Springs 5 can be made as an integral part of parallel 3, as shown in FIG. 3, or from separate pieces of bent spring wire. Pins 7 fitting in holes 8 limit the travel of parallels 3 by engaging in slots 6. Front edge of parallel 3 can be smooth or notched as shown in parallel 3′. Notches allow the through-drilling of holes close to the edge of jaws 4. Jaw 4 can be slotted as shown, or can be made from separate parallel layers separated by spacers slightly thicker than the parallels 3, typically 10-20 um thicker. When jaw 4 is made of separate layers, pins 7 should be replaced by screws in order to clamp all layers and spacers together. Other retractable feature, such as horizontal stops 10, can be added as well. Horizontal stop pins 10 are spring loaded by spring 11 and held in place by screw 12 inside precision bore 13. One side of pin 10 has a short flat 14 allowing screw 12 to stop the pin from fully coming out of bore 13.

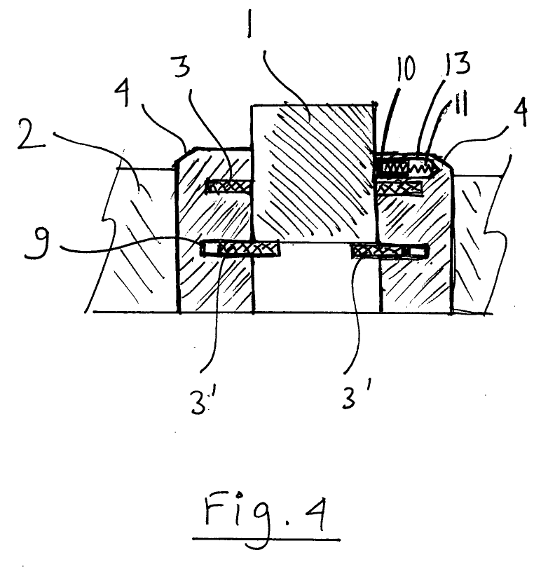

FIG. 4 shows a cross section of the vice. Parallels 3 slide in slots 9. In their normal position they are extended, but are retracted by the workpiece when not needed. Workpiece 1 is supported on parallels 3′ while parallels 3 are retracted. This allows the parallels to be an integral part of the vice, without the need to maintain separate sets of parallels.

What is claimed is:

1. A retractable workpiece locator for a machine vice, said locator retracting into jaw of said vice when not in use.

2. A locator as in claim 1 wherein said locator is spring loaded.

3. A machine vice having a plurality of retractable and spring loaded parallels.

4. A machine vice having at least one set of retractable parallels and at least one retractable horizontal stop.

5. A retractable workpiece locator as in claim wherein said locator is made of a hardened and ground thin plate retracting into a matching slot in said vice jaw.
